(19) United States
(12) Patent Application Publication
(10) Pub. No.: US 2026/0281236 A1
(43) Pub. Date: Sep. 17, 2026

(54) SYSTEM FOR COUNTERING NUISANCE CALLS

(71) Applicant: SoftBank Group Corp., Tokyo (JP)

(72) Inventor: Kentaro KITAGAWA, Tokyo (JP)

(21) Appl. No.: 19/561,536

(22) Filed: Mar. 10, 2026

Related U.S. Application Data
(60) Provisional application No. 63/770,994, filed on Mar. 13, 2025.

(51) Int. Cl. H04M 3/22

(52) U.S. Cl. CPC H04M 3/2281

(57) ABSTRACT

A system for protecting a user from nuisance calls and fraudulent calls. The system includes an incoming call detection unit, an automatic response unit, a phrase storage unit, a database unit, a risk assessment unit, and a display unit. The incoming call detection unit detects an incoming telephone call in real time, and the automatic response unit responds to a caller using a preset phrase. The phrase storage unit manages phrases set by the user, and the database unit accumulates and analyzes past nuisance call information. The risk assessment unit assesses the risk level of an incoming telephone call using AI technology, and the display unit visually presents the result to the user.

### CROSS-REFERENCE TO RELATED APPLICATIONS

This application is based upon and claims the benefit of priority from U.S. Provisional Patent Application No. 63/770,994, filed on Mar. 13, 2025, the entire contents of which are incorporated herein by reference.

### BACKGROUND

Japanese Unexamined Patent Publication No. 2022-180282 discloses a method, which is a persona chatbot control method performed by at least one processor, the method including a step of receiving a user utterance, a step of adding the user utterance to a prompt including an instruction sentence associated with a description regarding a character of a chatbot, a step of encoding the prompt, and a step of inputting the encoded prompt to a language model to generate a chatbot utterance responding to the user utterance.

### SUMMARY

The problem to be solved by this disclosure is to reduce the temporal, mental, and financial burden on users due to the increasing number of nuisance calls and fraudulent calls in modern society. Nuisance calls involve the risk of personal information leakage and fraud damage, and become a major source of stress for users. In addition, these calls take up important time in daily life and work, and are a factor in reducing efficiency. Conventional nuisance call countermeasures have relied on manual responses and simple number blocking, and there has been a problem that prompt and effective responses are difficult. Furthermore, the methods of nuisance calls are evolving daily, and there is also a problem that conventional methods cannot fully cope with new methods. By combining an automatic response system that utilizes AI technology with a risk assessment function based on past data, users are enabled to respond promptly and effectively to nuisance calls, thereby significantly reducing the burden on the users.

A nuisance call countermeasure system is provided. This system includes an incoming call detection unit that detects an incoming telephone call, an automatic response unit that automatically responds, a phrase storage unit that stores fixed phrases used during a response, a database unit that accumulates information on past nuisance calls, a risk assessment unit that assesses the risk level of an incoming call based on information accumulated in the database unit, and a display unit that displays the assessed risk level on a user's terminal. The incoming call detection unit detects an incoming telephone call in real time, and the automatic response unit promptly responds using a fixed phrase stored in the phrase storage unit. This makes it possible for a user to immediately respond to a nuisance call without directly answering the telephone. Furthermore, the database unit accumulates information on past nuisance calls, and the risk assessment unit assesses the risk level of an incoming call by utilizing AI technology based on this information. The assessment result is visually displayed on the user's terminal via the display unit, and the user can grasp the risk level before answering the telephone. In this way, the user can prevent damage from nuisance calls and fraudulent calls in advance and can use the telephone with peace of mind.

One of the technical features of the present disclosure is that a series of processes from incoming call detection to automatic response and risk assessment is not merely a general use of a generic computer, but organically combines signal processing in a communication protocol layer and inference processing by a machine learning model. In particular, by applying specific algorithms (for example, vectorization of acoustic feature amounts and semantic analysis by natural language processing) to huge amounts of call log data and real-time voice packets which cannot be processed by conventional human judgment or simple blacklist collation, the present disclosure solves problems specific to computer technology, such as reducing false positives while minimizing communication delay (latency). Thereby, the present system provides a concrete technical improvement that identifies and blocks security threats on a communication network with speed and accuracy substantially impossible to perform by human mental processes.

### BRIEF DESCRIPTION OF THE DRAWINGS

FIG. 1 is a conceptual diagram illustrating an example of a configuration of a data processing system according to a first embodiment.

FIG. 2 is a conceptual diagram illustrating an example of main functions of a data processing apparatus and a smart device according to the first embodiment.

FIG. 3 is a conceptual diagram illustrating an example of a configuration of a data processing system according to a second embodiment.

FIG. 4 is a conceptual diagram illustrating an example of main functions of a data processing apparatus and smart glasses according to the second embodiment.

FIG. 5 is a conceptual diagram illustrating an example of a configuration of a data processing system according to a third embodiment.

FIG. 6 is a conceptual diagram illustrating an example of main functions of a data processing apparatus and a headset-type terminal according to the third embodiment.

FIG. 7 is a conceptual diagram illustrating an example of a configuration of a data processing system according to a fourth embodiment.

FIG. 8 is a conceptual diagram illustrating an example of main functions of a data processing apparatus and a robot according to the fourth embodiment.

FIG. 9 illustrates an emotion map on which a plurality of emotions are mapped.

FIG. 10 illustrates an emotion map on which a plurality of emotions are mapped.

FIG. 11 is a flowchart illustrating an example of a method of countering nuisance calls.

### DETAILED DESCRIPTION

Hereinafter, example systems according to the technology of the present disclosure will be described with reference to the accompanying drawings.

First, terms used in the following description will be described.

In the following embodiments, a processor with a reference sign (hereinafter, simply referred to as a “processor”) may be one arithmetic device or may be a combination of a plurality of arithmetic devices. Also, the processor may be one type of arithmetic device or may be a combination of a plurality of types of arithmetic devices. Examples of the arithmetic device include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference sign is a memory in which information is temporarily stored, and is used as a work memory by a processor.

In the following embodiments, a storage with a reference sign is one or more non-volatile storage devices that store various programs, various parameters, and the like. Examples of the non-volatile storage device include a flash memory (SSD (Solid State Drive)), a magnetic disk (for example, a hard disk), or a magnetic tape, and the like.

In the following embodiments, a communication I/F (Interface) with a reference sign is an interface including a communication processor, an antenna, and the like. The communication I/F manages communication among a plurality of computers. An example of a communication standard applied to the communication I/F includes a wireless communication standard including 5G (5th Generation Mobile Communication System), Wi-Fi (registered trademark), or Bluetooth (registered trademark), and the like.

In the following embodiments, “A and/or B” is synonymous with “at least one of A and B”. That is, “A and/or B” means that it may be A only, B only, or a combination of A and B. Also, in the present specification, when three or more matters are expressed by being connected with “and/or”, the same concept as “A and/or B” is applied.

### First Embodiment

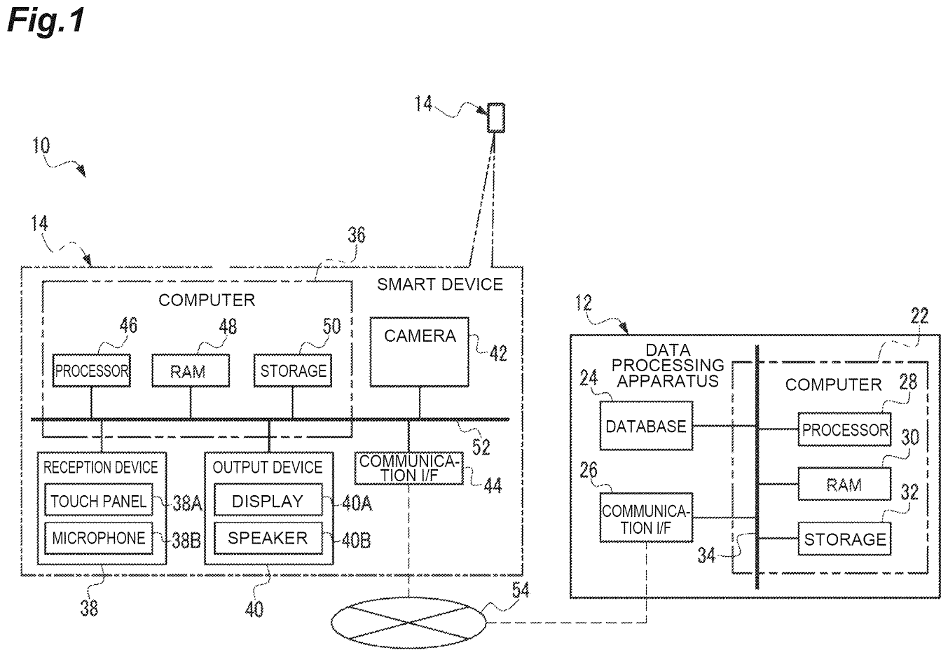

FIG. 1 illustrates an example of a configuration of a data processing system 10 according to a first embodiment.

As illustrated in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting a user's voice. A control unit 46A transmits data indicating the user input received by the touch panel 38A and the microphone 38B to the data processing apparatus 12. In the data processing apparatus 12, a specific processing unit 290 acquires the data indicating the user input.

The output device 40 includes a display 40A, a speaker 40B, and the like, and presents data to a user 20 by outputting the data in a representation form (for example, voice and/or text) perceivable by the user 20. The display 40A displays visible information such as text and images in accordance with an instruction from the processor 46. The speaker 40B outputs voice in accordance with an instruction from the processor 46. The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

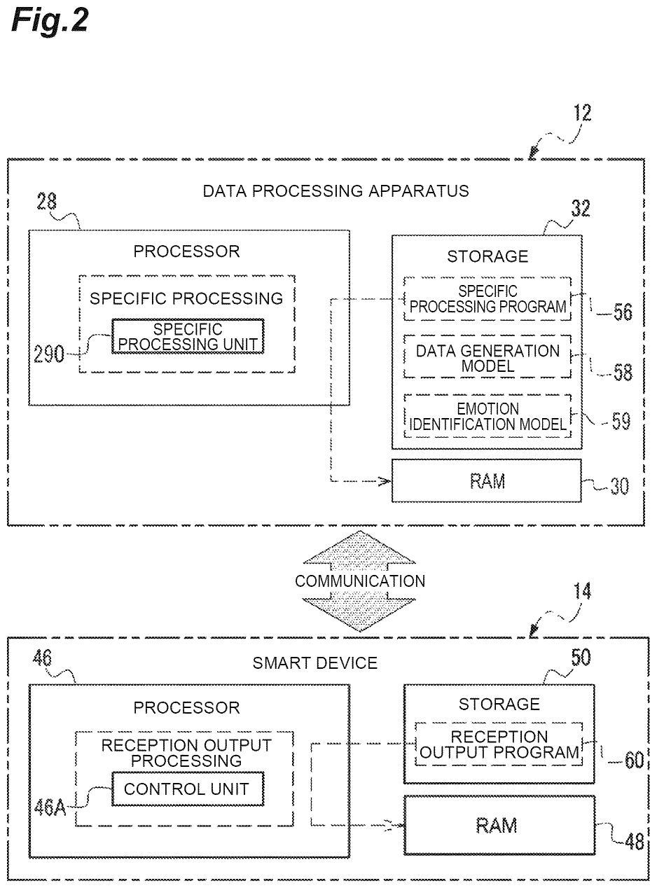

FIG. 2 illustrates an example of main functions of the data processing apparatus 12 and the smart device 14.

As illustrated in FIG. 2, in the data processing apparatus 12, specific processing is performed by the processor 28. A specific processing program 56 is stored in the storage 32. The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

In the smart device 14, reception output processing is performed by the processor 46. A reception output program 60 is stored in the storage 50. The reception output program 60 is used in combination with the specific processing program 56 by the data processing system 10. The processor 46 reads the reception output program 60 from the storage 50 and executes the read reception output program 60 on the RAM 48. The specific processing is realized by the processor 46 operating as a control unit 46A in accordance with the reception output program 60 executed on the RAM 48. Note that the smart device 14 can also have a data generation model and an emotion identification model similar to the data generation model 58 and the emotion identification model 59, and perform processing similar to that of the specific processing unit 290 using these models. The reception output processing is realized by the processor 46 operating as the control unit 46A in accordance with the reception output program 60 executed on the RAM 48.

Note that an apparatus other than the data processing apparatus 12 may have the data generation model 58. For example, a server apparatus (for example, a generation server) may have the data generation model 58. In this case, the data processing apparatus 12 obtains a processing result (such as a prediction result) in which the data generation model 58 is used, by communicating with the server apparatus having the data generation model 58. Also, the data processing apparatus 12 may be a server apparatus, or may be a terminal device owned by a user (for example, a mobile phone, a robot, a home appliance, etc.). Next, an example of processing by the data processing system 10 according to the first embodiment will be described.

### Example 1.1

A flow of specific processing in Example 1.1 will be described. Each unit of the system described below is realized by the data processing apparatus 12 and the smart device 14. Also, the data processing apparatus 12 is referred to as a “server”, and the smart device 14 is referred to as a “terminal”.

Disclosed herein is a nuisance call countermeasure system with a combination of a server and a terminal, and how each unit functions is shown below.

First, an incoming call detection unit is implemented in a terminal. This unit cooperates with a communication module of the terminal to detect an incoming telephone call in real time. For example, by cooperating with the operating system of the terminal and hooking an incoming call event, the information is acquired at the moment a telephone call arrives. For example, even if the terminal is in a standby state, a process operating in the background monitors for incoming calls, and when there is an incoming call, it immediately notifies the entire system. This notification is also transmitted to other modules within the terminal, and each unit of the system promptly starts operation.

The incoming call detection unit may be implemented as a background service resident in a telephony manager or a communication driver layer of an operating system (OS) of the smart device 14. For example, the incoming call detection unit may hook an interrupt upon receiving a ringing signal (Ringing Signal) or a Session Initiation Protocol (SIP) invitation, and extract a caller ID (Caller ID) and header information at a call control protocol (Call Control Protocol) level. This processing may be executed at a kernel level or a framework level before a user interface is displayed, and may be configured to transmit a trigger signal to the automatic response unit within several milliseconds from the incoming call.

The incoming call detection unit may be configured by, for example, the computer 36 (the processor 46 or the like) of the smart device 14, or may be configured by the control unit 46A, the reception output program 60, or the like.

Next, an automatic response unit is implemented in the terminal. This unit, upon receiving a notification from the incoming call detection unit, automatically responds using a fixed phrase stored in a phrase storage unit. For example, it uses speech synthesis technology to convey a preset phrase as voice to the caller. For example, by using a phrase such as “This call is being monitored by a nuisance call prevention system,” a warning is issued to the caller. It is also possible to use phrases customized by the user, enabling responses tailored to specific industries or situations. Furthermore, the response content is recorded, and it is also possible for the user to check it later.

The automatic response unit may be configured by, for example, the computer 36 (the processor 46 or the like) of the smart device 14, or may be configured by the control unit 46A, the reception output program 60, or the like.

A phrase storage unit is implemented in the terminal. This unit stores a plurality of fixed phrases set by the user and makes them available to the automatic response unit. For example, the user can add, delete, and edit phrases through a user interface. For example, it is possible to save phrases for general nuisance calls, phrases for specific fraud tactics, or phrases originally set by the user. This enables the user to select the optimal response according to the situation.

The phrase storage unit may be configured by, for example, the computer 36 (the processor 46 or the like) of the smart device 14, or may be configured by the control unit 46A, the reception output program 60, or the like.

A database unit is implemented on a server. This unit is responsible for accumulating and analyzing information on past nuisance calls. For example, it accumulates information such as telephone numbers, caller names, summaries of call content, dates and times of calls, and evaluations from users. This makes it possible to identify patterns of nuisance calls and to make a prompt judgment when a new nuisance call arrives. For example, the server operates in a cloud environment and aggregates and analyzes data from multiple users to identify nuisance calls with higher accuracy.

The database unit may be configured by, for example, the database 24 of the data processing apparatus 12.

A risk assessment unit is implemented on the server. This unit assesses the risk level of an incoming telephone call using AI technology based on the information accumulated in the database unit. For example, it uses a machine learning algorithm to learn patterns of nuisance calls from past data and collates a new incoming call against those patterns. For example, if a number has been reported as a nuisance call by many users in the past, the risk level is set high. In addition, by using AI technology, the content of the call and the caller's pattern can be analyzed to perform a more accurate risk assessment.

The evaluation process by AI technology in the risk assessment unit will be described in detail. The risk assessment unit executes an algorithm including the following steps:
(1) Feature extraction step: extracting acoustic feature amounts such as Mel-frequency cepstral coefficients (MFCC) and word data converted into text by speech recognition (STT) from call voice data.
(2) Vectorization step: converting the extracted text data into multidimensional vectors using an embedding technology such as Word2Vec or BERT (Bidirectional Encoder Representations from Transformers).
(3) Inference step: inputting the generated vectors into a recurrent neural network (RNN), particularly a Long Short-Term Memory (LSTM) network or a Transformer-based model, to calculate a similarity score (range of 0 to 1) with a fraud pattern.
(4) Determination step: determining that the incoming call is “dangerous” when the calculated score exceeds a predetermined threshold (for example, 0.8).
   This processing has learned millions of past fraud call patterns accumulated in the database 24 as training data, and can predict danger from context and emotional fluctuations (micro-tremors) even for unknown fraud methods (Zero-day attacks).

The risk assessment unit may be configured by, for example, the computer 22 (the processor 28 or the like) of the data processing apparatus 12, or may be configured by the specific processing unit 290, the specific processing program 56, the data generation model 58, or the like.

Finally, a display unit is implemented in the terminal. This unit visually displays the assessment result from the risk assessment unit on the user's terminal. For example, by indicating the assessment result with numerical values or color coding, it enables the user to intuitively grasp the risk level. For example, if the risk level is high, it is displayed in red, and if it is low, it is displayed in green. In addition, based on the assessment result, it is also possible to present a recommended action for the user to decide whether to answer the telephone. This allows the user to check the risk level before answering the telephone and take appropriate action.

The display unit may be configured by, for example, the output device 40 (the display 40A or the like) of the smart device 14.

The present system may adopt a distributed architecture for privacy protection and improvement of calculation efficiency. For example, a lightweight inference model (quantized neural network) and a hashed blacklist using a Bloom filter (Bloom Filter) may be cached in the smart device 14 (edge side). A configuration may be adopted in which a high-speed primary determination is first performed on the edge side upon an incoming call, and only an incoming call in a gray zone where determination is difficult is queried to the server (data processing apparatus 12). Thereby, a technical improvement effect is achieved in which concentration of load on the server is prevented while suppressing consumption of network bandwidth, and call privacy of the user is protected (only a hash value is transmitted instead of raw data).

The present system may optimize consumption of network bandwidth and battery consumption of the terminal by adopting a hybrid configuration of edge computing and cloud computing. For example, incoming call detection and initial lightweight filtering (simple blacklist collation or the like) may be executed by the processor 46 of the smart device 14 (edge side), and inference by a deep learning model with high calculation load and collation with a large-scale database may be executed by the processor 28 of the data processing apparatus 12 (cloud side). A configuration may be adopted in which the smart device 14 encrypts only a feature amount vector of call voice and transmits the encrypted feature amount vector to the data processing apparatus 12, thereby significantly reducing a communication data amount compared to a case of transmitting raw voice data, and protecting privacy.

In this way, the system provides a prompt and effective countermeasure against nuisance calls and fraudulent calls through the cooperative operation of a server and a terminal. The user can prevent damage from nuisance calls in advance and can use the telephone with peace of mind.

### System Configuration

The system includes an incoming call detection unit, an automatic response unit, a phrase storage unit, a database unit, a risk assessment unit, and a display unit. Each of these units operates in cooperation to effectively realize nuisance call countermeasures.

The incoming call detection unit is implemented in a terminal and is responsible for detecting an incoming telephone call in real time. This unit cooperates with a communication module of the terminal and hooks an incoming call event to acquire the information at the moment a telephone call arrives. For example, even if the terminal is in a standby state, a process operating in the background monitors for incoming calls, and when there is an incoming call, it immediately notifies the entire system. This notification is also transmitted to other modules within the terminal, and each unit of the system promptly starts operation. Furthermore, the incoming call detection unit can support different communication protocols and can detect not only voice calls but also incoming video calls and messaging applications.

The automatic response unit, upon receiving a notification from the incoming call detection unit, automatically responds using a fixed phrase stored in the phrase storage unit. This unit uses speech synthesis technology to convey a preset phrase as voice to the caller. For example, by using a phrase such as “This call is being monitored by a nuisance call prevention system,” a warning is issued to the caller. It is also possible to use phrases customized by the user, enabling responses tailored to specific industries or situations. Furthermore, the response content is recorded, and it is also possible for the user to check it later. The automatic response unit supports multiple languages and can also handle international nuisance calls.

The phrase storage unit stores a plurality of fixed phrases set by the user and makes them available to the automatic response unit. This unit allows the user to add, delete, and edit phrases through a user interface. For example, it is possible to save phrases for general nuisance calls, phrases for specific fraud tactics, or phrases originally set by the user. This enables the user to select the optimal response according to the situation. The phrase storage unit is linked with cloud storage, allowing the user to use the same phrases even when using different terminals.

The database unit is implemented on a server and is responsible for accumulating and analyzing information on past nuisance calls. This unit accumulates information such as telephone numbers, caller names, summaries of call content, dates and times of calls, and evaluations from users. This makes it possible to identify patterns of nuisance calls and to make a prompt judgment when a new nuisance call arrives. For example, the server operates in a cloud environment and aggregates and analyzes data from multiple users to identify nuisance calls with higher accuracy. The database unit is updated regularly to keep the information for responding to new nuisance call tactics up to date.

The risk assessment unit assesses the risk level of an incoming telephone call using AI technology based on the information accumulated in the database unit. This unit uses a machine learning algorithm to learn patterns of nuisance calls from past data and collates a new incoming call against those patterns. For example, if a number has been reported as a nuisance call by many users in the past, the risk level is set high. In addition, by using AI technology, the content of the call and the caller's pattern can be analyzed to perform a more accurate risk assessment. The risk assessment unit performs the assessment in real time, allowing the user to check the risk level before answering the telephone.

The display unit visually displays the assessment result from the risk assessment unit on the user's terminal. This unit indicates the assessment result with numerical values or color coding, enabling the user to intuitively grasp the risk level. For example, if the risk level is high, it is displayed in red, and if it is low, it is displayed in green. In addition, based on the assessment result, it is also possible to present a recommended action for the user to decide whether to answer the telephone. The display unit, as part of the user interface, can cooperate with other applications to display notifications.

Specific examples of prompt sentences to be read into a generative AI include “Design an algorithm for learning patterns of nuisance calls and assessing the risk level for new incoming calls” and “Construct a system that performs automatic responses using phrases set by the user”. These prompt sentences give instructions for the AI to operate each part of the system effectively, and are important for improving the accuracy and efficiency of the entire system.

### (Implementation Steps)

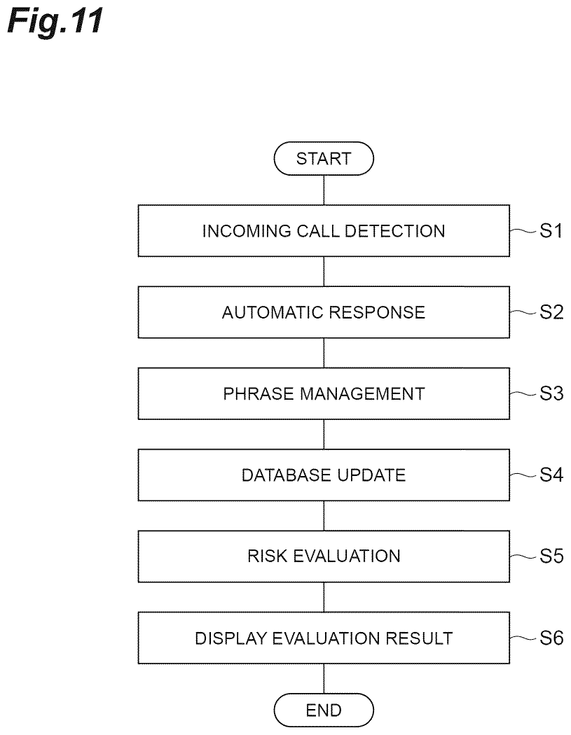

### Step 1: Incoming Call Detection (Refer to Step S1 of FIG. 11)

In this step, the incoming call detection unit implemented in the terminal detects an incoming telephone call in real time. By cooperating with the communication module of the terminal and hooking an incoming call event, the information is acquired at the moment a telephone call arrives. For example, even if the terminal is in a standby state, a process operating in the background monitors for incoming calls, and when there is an incoming call, it immediately notifies the entire system. This notification is also transmitted to other modules within the terminal, and each unit of the system promptly starts operation. Furthermore, the incoming call detection unit can support different communication protocols and can detect not only voice calls but also incoming video calls and messaging applications.

### Step 2: Automatic Response (Refer to Step S2 of FIG. 11)

The automatic response unit, having received a notification from the incoming call detection unit, automatically responds using a fixed phrase stored in the phrase storage unit. It conveys a preset phrase as voice to the caller using speech synthesis technology. For example, by using a phrase such as “This call is being monitored by a nuisance call prevention system,” a warning is issued to the caller. It is also possible to use phrases customized by the user, enabling responses tailored to specific industries or situations. Furthermore, the response content is recorded, and it is also possible for the user to check it later. The automatic response unit supports multiple languages and can also handle international nuisance calls.

### Step 3: Phrase Management (Refer to Step S3 of FIG. 11)

The phrase storage unit stores a plurality of fixed phrases set by the user and makes them available to the automatic response unit. The user can add, delete, and edit phrases through a user interface. For example, it is possible to save phrases for general nuisance calls, phrases for specific fraud tactics, or phrases originally set by the user. This enables the user to select the optimal response according to the situation. The phrase storage unit is linked with cloud storage, allowing the user to use the same phrases even when using different terminals.

### Step 4: Database Update (Refer to Step S4 of FIG. 11)

The database unit is implemented on a server and is responsible for accumulating and analyzing information on past nuisance calls. It accumulates information such as telephone numbers, caller names, summaries of call content, dates and times of calls, and evaluations from users. This makes it possible to identify patterns of nuisance calls and to make a prompt judgment when a new nuisance call arrives. For example, the server operates in a cloud environment and aggregates and analyzes data from multiple users to identify nuisance calls with higher accuracy. The database unit is updated regularly to keep the information for responding to new nuisance call tactics up to date.

### Step 5: Risk Assessment (Refer to Step S5 of FIG. 11)

The risk assessment unit assesses the risk level of an incoming telephone call using AI technology based on the information accumulated in the database unit. It uses a machine learning algorithm to learn patterns of nuisance calls from past data and collates a new incoming call against those patterns. For example, if a number has been reported as a nuisance call by many users in the past, the risk level is set high. In addition, by using AI technology, the content of the call and the caller's pattern can be analyzed to perform a more accurate risk assessment. A specific example of a prompt sentence to be read into the generative AI is “Design an algorithm for learning patterns of nuisance calls and assessing the risk level for new incoming calls”.

### Step 6: Display of Assessment Result (Refer to Step S6 of FIG. 11)

The display unit visually displays the assessment result from the risk assessment unit on the user's terminal. It enables the user to intuitively grasp the risk level by indicating the assessment result with numerical values or color coding. For example, if the risk level is high, it is displayed in red, and if it is low, it is displayed in green. In addition, based on the assessment result, it is also possible to present a recommended action for the user to decide whether to answer the telephone. The display unit, as part of the user interface, can cooperate with other applications to display notifications.

### (Specific Use Case)

For example, consider a use case where a nuisance call countermeasure system is implemented on a terminal that a user uses daily, and a nuisance call is received. In this system, the incoming call detection unit immediately detects the incoming telephone call and sends a notification to the entire system. The automatic response unit, upon receiving the notification, automatically responds to the caller by utilizing speech synthesis technology with a fixed phrase stored in the phrase storage unit. This response includes, for example, a warning phrase such as “This call is being monitored by a nuisance call prevention system.”

The phrase storage unit manages a plurality of phrases preset by the user and has a function of selecting the optimal phrase according to the situation. The user can set phrases for general nuisance calls or phrases for specific fraud tactics. This enables the user to automatically take an appropriate action according to the type of nuisance call.

The database unit is implemented on a server and accumulates and analyzes information on past nuisance calls. This information includes telephone numbers, caller names, summaries of call content, dates and times of calls, and evaluations from users. The database unit can identify patterns of nuisance calls based on this information and make a prompt judgment when a new nuisance call arrives.

The risk assessment unit assesses the risk level of an incoming telephone call using AI technology based on the information accumulated in the database unit. It uses a machine learning algorithm to learn patterns of nuisance calls from past data and collates a new incoming call against those patterns. For example, if a number has been reported as a nuisance call by many users in the past, the risk level is set high. A specific example of a prompt sentence to be read into the generative AI is “Design an algorithm for learning patterns of nuisance calls and assessing the risk level for new incoming calls”.

The display unit visually displays the assessment result from the risk assessment unit on the user's terminal. The assessment result is indicated by numerical values or color coding, enabling the user to intuitively grasp the risk level. For example, if the risk level is high, it is displayed in red, and if it is low, it is displayed in green. In addition, based on the assessment result, it is also possible to present a recommended action for the user to decide whether to answer the telephone.

In this way, the nuisance call countermeasure system enables a user to prevent damage from nuisance calls and fraudulent calls in advance and to use the telephone with peace of mind. The system provides a prompt and effective nuisance call countermeasure through the cooperative operation of a server and a terminal.

### Example 1.2

A flow of specific processing in Example 1.2 will be described. Each unit of the system described below is realized by the data processing apparatus 12 and the smart device 14. Also, the data processing apparatus 12 is referred to as a “server”, and the smart device 14 is referred to as a “terminal”.

The system provides a security alert system and enables real-time threat detection and prompt response. This system includes a sensor detection unit, an automatic alert unit, an alert message storage unit, a database unit, a risk assessment unit, and a display unit.

First, the sensor detection unit detects abnormal movements within an area using physical sensors. This unit includes various sensors such as open/close sensors installed on doors and windows, motion detection sensors, acoustic sensors, and further, temperature sensors and vibration sensors. For example, if a door is opened illegally, the open/close sensor immediately senses the movement and sends a notification to the system. In addition, a motion detection sensor senses an abnormality when human movement is detected late at night, and an acoustic sensor informs of the presence of an intruder by detecting the sound of breaking glass or a loud noise. A temperature sensor can detect an abnormal temperature rise and capture the initial signs of a fire. A vibration sensor plays a role in early detection of destructive acts by sensing impacts on walls and windows. When these sensors sense an abnormality, a notification is immediately transmitted to the entire system, and the process proceeds to the next step.

Next, the automatic alert unit receives a notification from the sensor detection unit and notifies the user using a preset alert message. This unit issues a warning to the user through a voice message, a text message, or an application notification. For example, it sends a message such as “Suspicious movement has been detected. Please check immediately.” to a smartphone. This allows the user to quickly check the situation and take necessary action. The automatic alert unit supports multiple languages and can also handle international security needs. Furthermore, the alert is sent simultaneously to multiple devices specified by the user, so the user can respond promptly no matter where they are.

The alert message storage unit stores a plurality of alert messages set by the user and makes them available to the automatic alert unit. This unit allows the user to add, delete, and edit alert messages through a user interface. For example, it is possible to set a warning message for a specific time period or a custom message for a specific sensor. This enables the user to select the optimal alert according to the situation. In addition, the alert message can also be played back as voice using speech synthesis technology according to the user's preference.

The database unit accumulates and analyzes information on past security events. This unit accumulates information such as the detected date and time, location, sensor type, and evaluation from the user. This makes it possible to identify patterns of security threats and to make a prompt judgment when a new threat occurs. For example, it is possible to identify abnormalities that occur frequently during a specific time period or threats that occur repeatedly at a specific location. The database unit is updated regularly to keep the information for responding to new threat tactics up to date. Furthermore, the database is operated in a cloud environment and aggregates and analyzes data from multiple users to identify threats with higher accuracy.

The risk assessment unit assesses the risk level of a detected event using AI technology based on the information accumulated in the database unit. This unit uses a machine learning algorithm to learn threat patterns from past data and collates a new event against those patterns. For example, if a pattern has been reported as high risk by many users in the past, the risk level is set high. A specific example of a prompt sentence to be read into the generative AI is “Design an algorithm for detecting security threats and assessing the risk level in real time”. The risk assessment unit performs the assessment in real time, allowing the user to respond promptly.

Finally, the display unit visually displays the assessment result from the risk assessment unit on the user's terminal. This unit indicates the assessment result with numerical values or color coding, enabling the user to intuitively grasp the risk level. For example, if the risk level is high, it is displayed in red, and if it is low, it is displayed in green. In addition, based on the assessment result, it is also possible to present a recommended action for the user to take. This allows the user to respond promptly and appropriately. The display unit, as part of the user interface, can cooperate with other applications to display notifications.

In this way, the system becomes a powerful tool for enabling real-time threat detection and prompt response, and for ensuring the user's safety. The system provides a prompt and effective security countermeasure through the cooperative operation of a server and a terminal.

### System Configuration

The system includes a sensor detection unit, an automatic alert unit, an alert message storage unit, a database unit, a risk assessment unit, and a display unit. Each of these units forms the core of the security alert system and enables real-time threat detection and prompt response.

The sensor detection unit detects abnormal movements within an area using physical sensors. This unit includes various sensors such as open/close sensors installed on doors and windows, motion detection sensors, acoustic sensors, temperature sensors, and vibration sensors. For example, if a door is opened illegally, the open/close sensor immediately senses the movement and sends a notification to the system. In addition, a motion detection sensor senses an abnormality when human movement is detected late at night, and an acoustic sensor informs of the presence of an intruder by detecting the sound of breaking glass or a loud noise. A temperature sensor can detect an abnormal temperature rise and capture the initial signs of a fire. A vibration sensor plays a role in early detection of destructive acts by sensing impacts on walls and windows. When these sensors sense an abnormality, a notification is immediately transmitted to the entire system, and the process proceeds to the next step.

The automatic alert unit receives a notification from the sensor detection unit and notifies the user using a preset alert message. This unit issues a warning to the user through a voice message, a text message, or an application notification. For example, it sends a message such as “Suspicious movement has been detected. Please check immediately.” to a smartphone. This allows the user to quickly check the situation and take necessary action. The automatic alert unit supports multiple languages and can also handle international security needs. Furthermore, the alert is sent simultaneously to multiple devices specified by the user, so the user can respond promptly no matter where they are.

The alert message storage unit stores a plurality of alert messages set by the user and makes them available to the automatic alert unit. This unit allows the user to add, delete, and edit alert messages through a user interface. For example, it is possible to set a warning message for a specific time period or a custom message for a specific sensor. This enables the user to select the optimal alert according to the situation. In addition, the alert message can also be played back as voice using speech synthesis technology according to the user's preference.

The database unit accumulates and analyzes information on past security events. This unit accumulates information such as the detected date and time, location, sensor type, and evaluation from the user. This makes it possible to identify patterns of security threats and to make a prompt judgment when a new threat occurs. For example, it is possible to identify abnormalities that occur frequently during a specific time period or threats that occur repeatedly at a specific location. The database unit is updated regularly to keep the information for responding to new threat tactics up to date. Furthermore, the database is operated in a cloud environment and aggregates and analyzes data from multiple users to identify threats with higher accuracy.

The risk assessment unit assesses the risk level of a detected event using AI technology based on the information accumulated in the database unit. This unit uses a machine learning algorithm to learn threat patterns from past data and collates a new event against those patterns. For example, if a pattern has been reported as high risk by many users in the past, the risk level is set high. A specific example of a prompt sentence to be read into the generative AI is “Design an algorithm for detecting security threats and assessing the risk level in real time”. The risk assessment unit performs the assessment in real time, allowing the user to respond promptly.

The display unit visually displays the assessment result from the risk assessment unit on the user's terminal. This unit indicates the assessment result with numerical values or color coding, enabling the user to intuitively grasp the risk level. For example, if the risk level is high, it is displayed in red, and if it is low, it is displayed in green. In addition, based on the assessment result, it is also possible to present a recommended action for the user to take. This allows the user to respond promptly and appropriately. The display unit, as part of the user interface, can cooperate with other applications to display notifications.

In this way, the system becomes a powerful tool for enabling real-time threat detection and prompt response, and for ensuring the user's safety. The system provides a prompt and effective security countermeasure through the cooperative operation of a server and a terminal.

### (Implementation Steps)

### Step 1: Anomaly Detection by Sensors

In this step, the sensor detection unit detects abnormal movements within an area in real time. Open/close sensors installed on doors and windows sense physical opening and closing movements, and motion detection sensors capture the movement of people and objects. Acoustic sensors detect the sound of breaking glass or loud noises, and temperature sensors capture the initial signs of a fire by sensing abnormal temperature rises. Vibration sensors play a role in early detection of destructive acts by sensing impacts on walls and windows. When these sensors sense an abnormality, a notification is immediately transmitted to the entire system, and the process proceeds to the next step.

### Step 2: Issuance of Automatic Alert

The Automatic Alert Unit, Having Received a Notification from the Sensor detection unit, notifies the user using a preset alert message. This unit issues a warning to the user through a voice message, a text message, or an application notification. For example, it sends a message such as “Suspicious movement has been detected. Please check immediately.” to a smartphone. This allows the user to quickly check the situation and take necessary action. The automatic alert unit supports multiple languages and can also handle international security needs.

### Step 3: Management of Alert Messages

The alert message storage unit stores a plurality of alert messages set by the user and makes them available to the automatic alert unit. This unit allows the user to add, delete, and edit alert messages through a user interface. For example, it is possible to set a warning message for a specific time period or a custom message for a specific sensor. This enables the user to select the optimal alert according to the situation. In addition, the alert message can also be played back as voice using speech synthesis technology according to the user's preference.

### Step 4: Update and Analysis of Database

The database unit accumulates and analyzes information on past security events. This unit accumulates information such as the detected date and time, location, sensor type, and evaluation from the user. This makes it possible to identify patterns of security threats and to make a prompt judgment when a new threat occurs. For example, it is possible to identify abnormalities that occur frequently during a specific time period or threats that occur repeatedly at a specific location. The database unit is updated regularly to keep the information for responding to new threat tactics up to date.

### Step 5: Assessment of Risk Level

The risk assessment unit assesses the risk level of a detected event using AI technology based on the information accumulated in the database unit. This unit uses a machine learning algorithm to learn threat patterns from past data and collates a new event against those patterns. For example, if a pattern has been reported as high risk by many users in the past, the risk level is set high. A specific example of a prompt sentence to be read into the generative AI is “Design an algorithm for detecting security threats and assessing the risk level in real time”. The risk assessment unit performs the assessment in real time, allowing the user to respond promptly.

### Step 6: Display of Assessment Result

The display unit visually displays the assessment result from the risk assessment unit on the user's terminal. This unit indicates the assessment result with numerical values or color coding, enabling the user to intuitively grasp the risk level. For example, if the risk level is high, it is displayed in red, and if it is low, it is displayed in green. In addition, based on the assessment result, it is also possible to present a recommended action for the user to take. This allows the user to respond promptly and appropriately. The display unit, as part of the user interface, can cooperate with other applications to display notifications.

### (Specific Use Case)

For example, consider a case where the security alert system is implemented in a residence. In this residence, open/close sensors are installed on doors and windows, and motion detection sensors monitor movements both indoors and outdoors. Furthermore, acoustic sensors are installed to detect the sound of breaking glass or abnormal noises, and temperature sensors are installed to capture the initial signs of a fire. Vibration sensors are arranged to sense impacts on walls and windows.

When an intruder tries to pry open a window at night, this system immediately senses the movement with the open/close sensor and sends a notification to the entire system. The motion detection sensor captures the movement of the intruder crossing the yard, and the acoustic sensor detects the sound of breaking glass. The information from these sensors is aggregated in the system, and the automatic alert unit sends a warning to the user's smartphone using a preset alert message.

The user receives, for example, a message such as “Suspicious movement has been detected. Please check immediately.” and can quickly check the situation. The alert message storage unit manages a plurality of alert messages set by the user and can provide custom messages according to a specific time period or sensor.

The database unit accumulates and analyzes the information of these security events. For example, it can identify abnormalities that have occurred in a similar time period in the past or threats that occur repeatedly at a specific location. The risk assessment unit assesses the risk level of a detected event using AI technology based on the information accumulated in the database. A specific example of a prompt sentence to be read into the generative AI is “Design an algorithm for detecting security threats and assessing the risk level in real time”.

The display unit visually displays the assessment result from the risk assessment unit on the user's terminal. For example, if the risk level is high, it is displayed in red, and if it is low, it is displayed in green. In addition, based on the assessment result, it is also possible to present a recommended action for the user to take. This allows the user to respond promptly and appropriately.

In this way, the security alert system enhances security in a residence and provides an environment where the user can live with peace of mind. The system becomes a powerful tool for enabling real-time threat detection and prompt response, and for ensuring the user's safety.

The specific processing unit 290 transmits a result of the specific processing to the smart device 14. In the smart device 14, the control unit 46A causes the output device 40 to output the result of the specific processing. The microphone 38B acquires voice indicating a user input for the result of the specific processing. The control unit 46A transmits voice data indicating the user input acquired by the microphone 38B to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the smart device 14.

### Second Embodiment

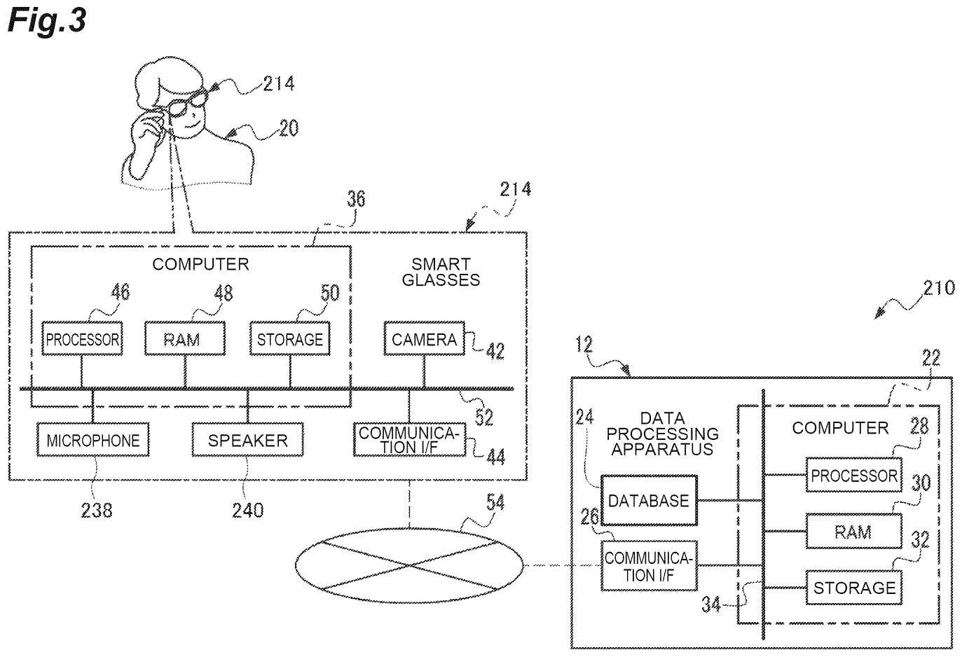

FIG. 3 illustrates an example of a configuration of a data processing system 210 according to a second embodiment.

As illustrated in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

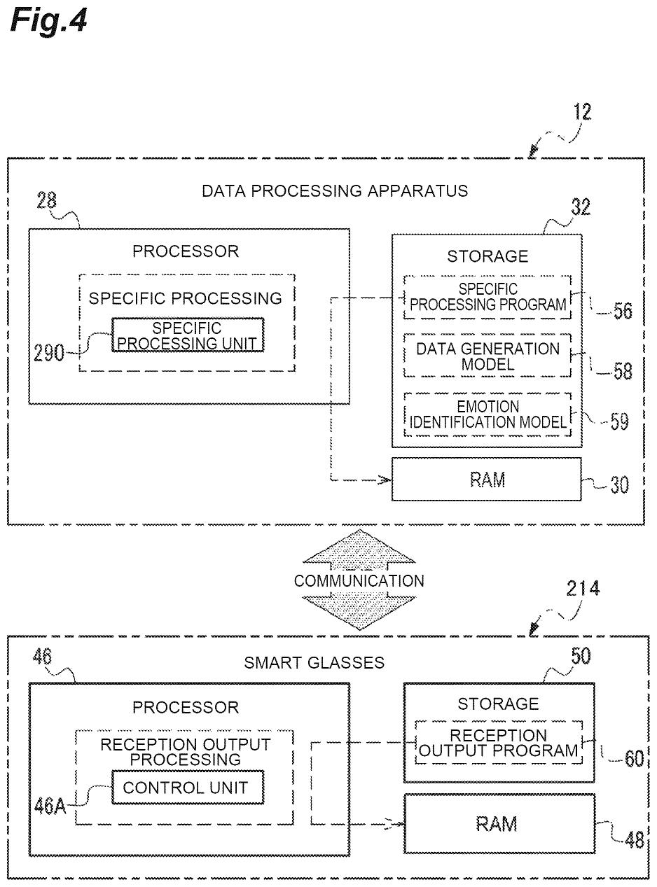

FIG. 4 illustrates an example of main functions of the data processing apparatus 12 and the smart glasses 214. As illustrated in FIG. 4, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

In the smart glasses 214, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48. Note that the smart glasses 214 can also have a data generation model and an emotion identification model similar to the data generation model 58 and the emotion identification model 59, and perform processing similar to that of the specific processing unit 290 using these models.

Next, specific processing by the specific processing unit 290 of the data processing apparatus 12 will be described. Each unit of the system described below is realized by the data processing apparatus 12 and the smart glasses 214. In the following description, the data processing apparatus 12 is referred to as a “server”, and the smart glasses 214 are referred to as a “terminal”.

### Example 2.1

Since the flow of the specific processing is the same as that in Example 1.1 described in the first embodiment, a description thereof is omitted.

### Example 2.2

Since the flow of the specific processing is the same as that in Example 1.2 described in the first embodiment, a description thereof is omitted.

The specific processing unit 290 transmits a result of the specific processing to the smart glasses 214. In the smart glasses 214, the control unit 46A causes the speaker 240 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the smart glasses 214.

### Third Embodiment

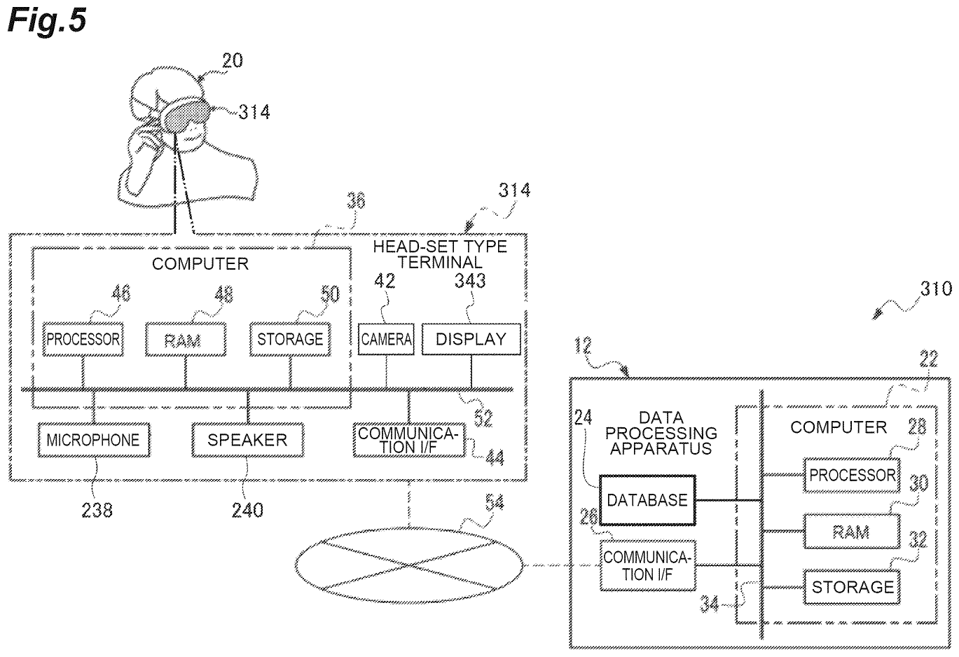

FIG. 5 illustrates an example of a configuration of a data processing system 310 according to a third embodiment.

As illustrated in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

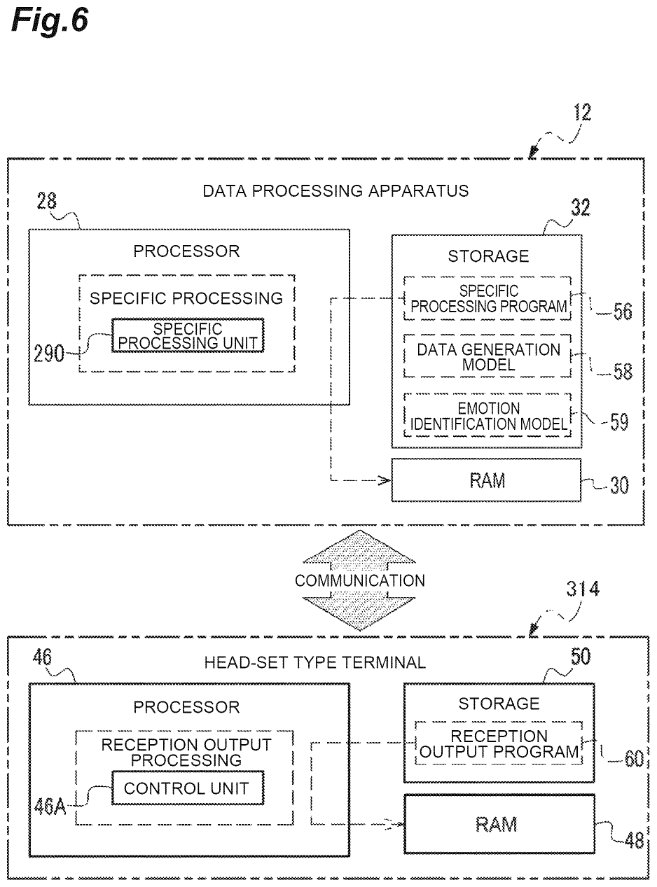

FIG. 6 illustrates an example of main functions of the data processing apparatus 12 and the headset-type terminal 314. As illustrated in FIG. 6, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the headset-type terminal 314, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the headset-type terminal 314. In the following description, the data processing apparatus 12 is referred to as a “server”, and the headset-type terminal 314 is referred to as a “terminal”.

### Example 3.1

Since the flow of the specific processing is the same as that in Example 1.1 described in the first embodiment, a description thereof is omitted.

### Example 3.2

Since the flow of the specific processing is the same as that in Example 1.2 described in the first embodiment, a description thereof is omitted.

The specific processing unit 290 transmits a result of the specific processing to the headset-type terminal 314. In the headset-type terminal 314, the control unit 46A causes the speaker 240 and the display 343 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the headset-type terminal 314.

### Fourth Embodiment

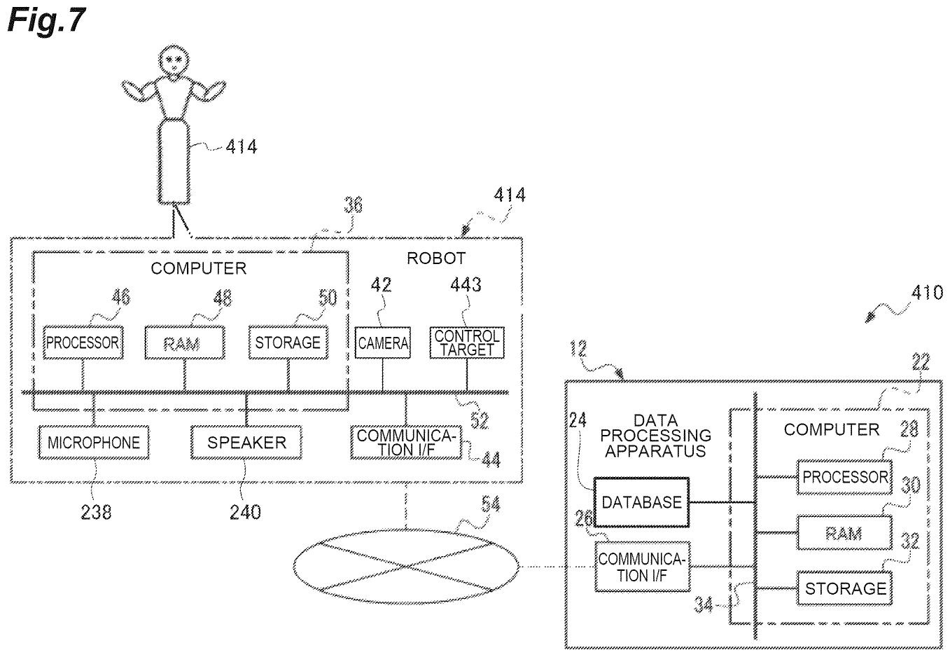

FIG. 7 illustrates an example of a configuration of a data processing system 410 according to a fourth embodiment.

As illustrated in FIG. 7, the data processing system 410 includes a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

The control target 443 includes a display device, an LED of an eye part, and motors that drive an arm, a hand, a leg, and the like. The posture and gestures of the robot 414 are controlled by controlling the motors of the arm, hand, leg, and the like. A part of the emotions of the robot 414 can be expressed by controlling these motors. Also, the facial expression of the robot 414 can also be expressed by controlling the light emission state of the LED of the eye part of the robot 414.

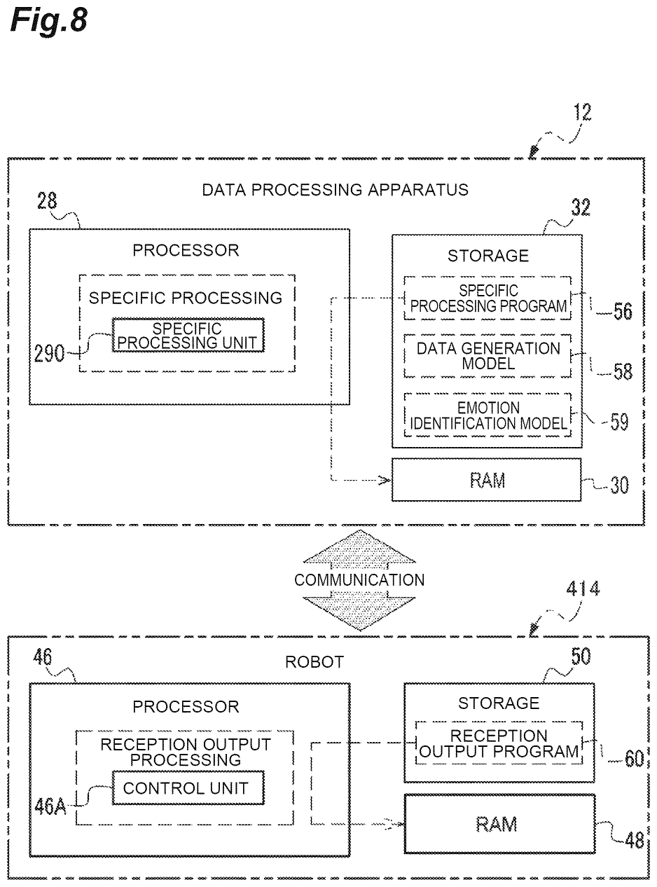

FIG. 8 illustrates an example of main functions of the data processing apparatus 12 and the robot 414. As illustrated in FIG. 8, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the robot 414, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the robot 414. In the following description, the data processing apparatus 12 is referred to as a “server”, and the robot 414 is referred to as a “terminal”.

### Example 4.1

Since the flow of the specific processing is the same as that in Example 1.1 described in the first embodiment, a description thereof is omitted.

### Example 4.2

Since the flow of the specific processing is the same as that in Example 1.2 described in the first embodiment, a description thereof is omitted.

The specific processing unit 290 transmits a result of the specific processing to the robot 414. In the robot 414, the control unit 46A causes the speaker 240 and the control target 443 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the robot 414.

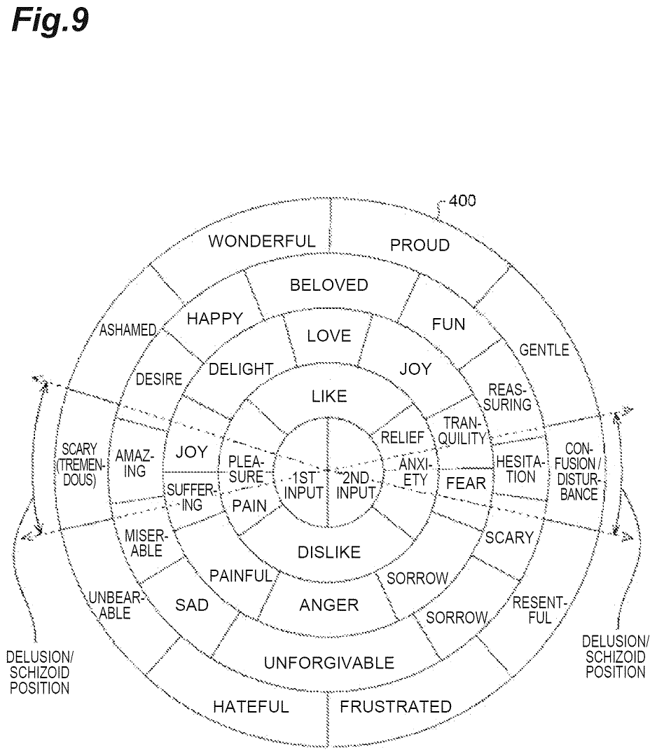

Note that the emotion identification model 59 as an emotion engine may determine a user's emotion according to a specific mapping. For example, the emotion identification model 59 may determine the user's emotion according to an emotion map (see FIG. 9), which is a specific mapping. Also, the emotion identification model 59 may similarly determine the robot's emotion, and the specific processing unit 290 may perform specific processing using the robot's emotion.

FIG. 9 is a diagram illustrating an emotion map 400 on which a plurality of emotions are mapped. In the emotion map 400, emotions are arranged in concentric circles radiating from the center. The closer to the center of the concentric circles, the more primitive the state of the emotion is arranged. On the outer side of the concentric circles, emotions representing states and actions arising from a state of mind are arranged. Emotion is a concept that also includes affect and mental states. On the left side of the concentric circles, emotions generated from reactions that generally occur in the brain are arranged. On the right side of the concentric circles, emotions that are generally induced by situational judgment are arranged. In the upward and downward directions of the concentric circles, emotions that are generated from reactions that generally occur in the brain and are induced by situational judgment are arranged. Also, on the upper side of the concentric circles, “pleasant” emotions are arranged, and on the lower side, “unpleasant” emotions are arranged. In this way, in the emotion map 400, a plurality of emotions are mapped based on the structure in which emotions are generated, and emotions that are likely to occur at the same time are mapped close to each other.

These emotions are distributed in the 3 o'clock direction of the emotion map 400, and usually go back and forth between relief and anxiety. In the right half of the emotion map 400, situational awareness is superior to internal sensations, resulting in a calm impression.

Since the inside of the emotion map 400 represents the inside of the mind and the outside of the emotion map 400 represents actions, the further one goes to the outside of the emotion map 400, the more visible (manifested in action) the emotion becomes.

Here, human emotions are based on various balances such as posture and blood sugar levels, and show a state of unpleasantness when those balances move away from the ideal, and a state of pleasantness when they approach the ideal. In robots, automobiles, motorcycles, and the like as well, emotions can be created based on various balances such as posture and remaining battery level, so as to show a state of unpleasantness when those balances move away from the ideal, and a state of pleasantness when they approach the ideal. The emotion map may be generated based on, for example, Dr. Mitsuyoshi's emotion map (Research on a speech emotion recognition and brain physiological signal analysis system of affect, Tokushima University, doctoral dissertation: https://ci.nii.ac.jp/naid/500000375379). In the left half of the emotion map, emotions belonging to a region called “reaction” where sensation is dominant are arranged. Also, in the right half of the emotion map, emotions belonging to a region called “situation” where situational awareness is dominant are arranged.

In the emotion map, two emotions that promote learning are defined. One is an emotion around the middle of negative “remorse” and “reflection” on the situation side. That is, it is when a negative emotion such as “I never want to feel this way again” or “I don't want to be scolded anymore” arises in the robot. The other is an emotion around positive “desire” on the reaction side. That is, it is when there is a positive feeling such as “I want more” or “I want to know more”.

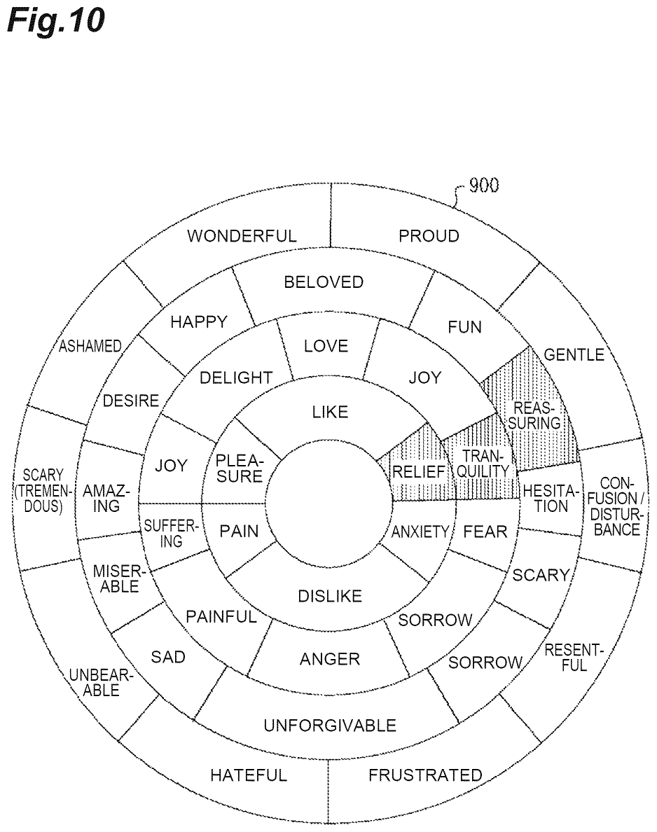

The emotion identification model 59 inputs a user input into a pre-trained neural network, acquires an emotion value indicating each emotion shown in the emotion map 400, and determines the user's emotion. This neural network is pre-trained based on a plurality of learning data that are combinations of user inputs and emotion values indicating each emotion shown in the emotion map 400. Also, this neural network is trained such that emotions arranged close to each other have close values, as in the emotion map 900 shown in FIG. 10. FIG. 10 shows an example in which a plurality of emotions, “relief,” “peace of mind,” and “reassured,” have close emotion values.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program that runs on a personal computer, or an application that runs on a smartphone or the like. The method according to the present disclosure may be provided to a user in a SaaS (Software as a Service) format.

An example form in which the specific processing is performed by one computer 22 has been described, but the technology of the present disclosure is not limited to this, and distributed processing for the specific processing may be performed by a plurality of computers including the computer 22. For example, the data generation model 58 may be provided in an external device of the data processing apparatus 12, and the external device may generate data according to the input data.

An example form in which the specific processing program 56 is stored in the storage 32 has been described, but the technology of the present disclosure is not limited to this. For example, the specific processing program 56 may be stored in a portable computer-readable non-transitory storage medium such as a USB (Universal Serial Bus) memory. The specific processing program 56 stored in the non-transitory storage medium is installed in the computer 22 of the data processing apparatus 12. The processor 28 executes the specific processing according to the specific processing program 56.

Also, the specific processing program 56 may be stored in a storage device such as a server connected to the data processing apparatus 12 via the network 54, and the specific processing program 56 may be downloaded in response to a request from the data processing apparatus 12 and installed in the computer 22.

Note that it is not necessary to store all of the specific processing program 56 in a storage device such as a server connected to the data processing apparatus 12 via the network 54, or to store all of the specific processing program 56 in the storage 32, and a part of the specific processing program 56 may be stored.

As hardware resources for executing the specific processing, various processors shown below can be used. Examples of the processor include a CPU, which is a general-purpose processor that functions as a hardware resource for executing the specific processing by executing software, that is, a program. Also, examples of the processor include a dedicated electric circuit, which is a processor having a circuit configuration specifically designed to execute specific processing, such as an FPGA (Field-Programmable Gate Array), a PLD (Programmable Logic Device), or an ASIC (Application Specific Integrated Circuit). A memory is built in or connected to any of the processors, and any of the processors executes the specific processing by using the memory.

The hardware resource that executes the specific processing may be configured by one of these various processors, or may be configured by a combination of two or more processors of the same type or different types (for example, a combination of a plurality of FPGAs, or a combination of a CPU and an FPGA). Also, the hardware resource that executes the specific processing may be one processor.

As an example of a configuration with one processor, first, there is a form in which one processor is configured by a combination of one or more CPUs and software, and this processor functions as a hardware resource for executing the specific processing. Second, there is a form in which a processor that realizes the functions of an entire system including a plurality of hardware resources for executing the specific processing with one IC chip, as represented by an SoC (System-on-a-chip) or the like, is used. In this way, the specific processing is realized using one or more of the various processors described above as hardware resources.

Furthermore, as a hardware structure of these various processors, an electric circuit in which circuit elements such as semiconductor elements are combined can be used. Also, the specific processing described above is merely an example. Therefore, it goes without saying that unnecessary steps may be deleted, new steps may be added, or the processing order may be changed within a scope that does not depart from the gist.

The description and illustrations shown above are detailed descriptions of the parts related to the technology of the present disclosure, and are merely an example of the technology of the present disclosure. For example, the description regarding the above-described configuration, function, operation, and effect is a description regarding an example of the configuration, function, operation, and effect of the part related to the technology of the present disclosure. Therefore, it goes without saying that unnecessary parts may be deleted, new elements may be added, or replacements may be made to the description and illustrations shown above within a scope that does not depart from the gist of the technology of the present disclosure. Also, in order to avoid confusion and facilitate understanding of the parts related to the technology of the present disclosure, in the description and illustrations shown above, descriptions regarding common general technical knowledge and the like that do not require particular explanation for enabling the implementation of the technology of the present disclosure are omitted.

All documents, patent applications, and technical standards described in this specification are incorporated herein by reference to the same extent as if each individual document, patent application, and technical standard were specifically and individually indicated to be incorporated by reference.

It is to be understood that not all aspects, advantages and features described herein may necessarily be achieved by, or included in, any one particular example. Indeed, having described and illustrated various examples herein, it should be apparent that other examples may be modified in arrangement and detail.

A security alert system, the system comprising a sensor detection unit, an automatic alert unit, an alert message storage unit, a database unit, a risk assessment unit, and a display unit. The sensor detection unit detects abnormal movements within an area in real time using physical sensors, and monitors things such as the opening and closing of doors and windows, and suspicious movements by a motion detection sensor. The automatic alert unit receives a notification from the sensor detection unit, automatically notifies a user using a preset alert message, and issues a warning through a voice message, a text message, or an application notification. The alert message storage unit stores a plurality of alert messages set by the user, makes them available to the automatic alert unit, and makes it possible to add, delete, and edit alert messages through a user interface. The database unit accumulates and analyzes information on past security events, and accumulates the detected date and time, location, sensor type, and evaluation from the user. The risk assessment unit assesses the risk level of a detected event using AI technology based on information accumulated in the database unit, learns threat patterns from past data using a machine learning algorithm, and collates new events against those patterns. The display unit visually displays the assessment result from the risk assessment unit on the user's terminal, indicates the assessment result with numerical values or color coding, and enables the user to intuitively grasp the risk level.

In some examples, the sensor detection unit supports different communication protocols and can detect not only voice calls but also incoming video calls and messaging applications. The sensor detection unit has a function in which a process operating in the background monitors for incoming calls, and when there is an incoming call, it immediately notifies the entire system, thereby enabling each unit of the system to promptly start operation.

In some examples, the risk assessment unit performs an assessment in real time, allowing a user to check the risk level before answering a telephone. The risk assessment unit can perform a more accurate risk assessment by analyzing the content of the call and the caller's pattern using AI technology, and can also present a recommended action for the user to take based on the assessment result.

An example system for countering nuisance calls may include circuitry. The circuitry may be configured to: detect an incoming call; assess a risk level of the incoming call based on information on a past nuisance call recorded in a database; and display the assessed risk level on a terminal of a user.

In some examples, the circuitry may be further configured to, when the incoming call is detected, automatically respond using a predetermined fixed phrase and record response content in the database.

In some examples, assessing the risk level may include assessing the risk level of the incoming call in real time based on the information on the past nuisance call stored in the database and an analysis result using AI technology.

In some examples, displaying the risk level on the terminal of the user may include indicating the risk level with a numerical value or color coding.

In some examples, the circuitry may be further configured to accept feedback from the user and reflect the feedback in the database.

An example method of countering nuisance calls may include: detecting an incoming call; assessing a risk level of the incoming call based on information on a past nuisance call recorded in a database; and displaying the assessed risk level on a terminal of a user.

What is claimed is:

1. A system for countering nuisance calls, the system comprising circuitry:
wherein the circuitry is configured to:
detect an incoming call;
assess a risk level of the incoming call based on information on a past nuisance call recorded in a database; and
display the assessed risk level on a terminal of a user.

2. The system according to claim 1, wherein the circuitry is further configured to, when the incoming call is detected, automatically respond using a predetermined fixed phrase and record response content in the database.

3. The system according to claim 1, wherein assessing the risk level includes assessing the risk level of the incoming call in real time based on the information on the past nuisance call stored in the database and an analysis result using AI technology.

4. The system according to claim 1, wherein displaying the risk level on the terminal of the user includes indicating the risk level with a numerical value or color coding.

5. The system according to claim 1, wherein the circuitry is further configured to accept feedback from the user and reflect the feedback in the database.

6. A method of countering nuisance calls, the method comprising:
detecting an incoming call;
assessing a risk level of the incoming call based on information on a past nuisance call recorded in a database; and
displaying the assessed risk level on a terminal of a user.
